(19) United States
(12) Patent Application Publication
(10) Pub. No.: US 2015/0084985 A1
(43) Pub. Date: Mar. 26, 2015

(54) SEAT ADJUSTMENT FOR A MOTOR VEHICLE

(71) Applicant: FAURECIA SIEGES D'AUTOMOBILE, Nanterre (FR)

(72) Inventor: Samuel Baudu, Boulogne Billancourt (FR)

(21) Appl. No.: 14/388,635

(22) PCT Filed: Mar. 26, 2013
(86) PCT No.: PCT/FR2013/050650

§ 371 Date: Sep. 26, 2014

(30) Foreign Application Priority Data
Mar. 29, 2012 (FR) 1252822

(51) Int. Cl. B60N 2/02; B60R 16/037; G06T 11/60; B60N 2/00

(52) U.S. Cl. CPC B60N 2/0252; B60N 2/002; B60R 16/037; G06T 11/60
USPC 345/629

(57) ABSTRACT

The invention concerns a method for adjusting a seat for a motor vehicle on the basis of measurements of a user, wherein said measurements are taken from a touch screen (42) of a device (4) provided with an imaging camera (44), the length of measuring templates superposed on an image of the user being adapted to correspond to the image.

### CROSS-REFERENCE TO RELATED APPLICATIONS

The present application is a National Stage of PCT International Application Serial Number PCT/FR2013/050650, filed Mar. 26, 2013, which claims priority under 35 U.S.C. §119 of French Patent Application Serial Number 12/52822, filed Mar. 29, 2012, the disclosures of which are incorporated by reference herein.

### BACKGROUND OF THE INVENTION

1. Field of the Invention

The present invention generally relates to motor vehicle seats and, more specifically, to the adjusting of an electric seat according to the user (driver or passenger). The invention more specifically applies to the automating of the configuration of a motor vehicle seat based on the user's morphologic data.

2. Description of the Related Art

In high-end vehicles, improving the user's comfort is an increasing concern. To begin with, seats have been motorized to enable to electrically adjust the seat configuration (height, forward position, backrest inclination, lumbar adjustment, etc.). It is now desired to further improve this comfort by performing an automated adjustment or pre-adjustment of the seat configuration based on the user's morphological data.

To perform this adjustment, the respective positions of the user's limb joints are generally determined to adjust the seat accordingly. Assessing such joint positions with the mere user size and weight indications is not sufficient.

It has already been provided, in document DE-A-2010028580, to improve this determination by exploiting a photograph of the user in a seated position to determine the respective proportions of his body parts with respect to one another. This document provides using a smartphone to take a picture of the user, storing it, and extracting therefrom, by image processing and analysis, the respective proportions of the user's limbs.

The exploiting of a photograph by image processing requires complex algorithms which take time to be executed. Further, the storage of the photograph in the non-volatile memory or mass storage of the phone takes up space in this memory, all the more as the accuracy of the photograph is high. Now, what is needed is not the actual photograph, but data relative to certain dimensions of the user's limbs.

Such an image storage further raises problems of collection of personal data and cannot be accepted by users, for privacy reasons.

Document DE-A-10 2010 028580 describes a device for adjusting the ergonomics of a vehicle seat, exploiting an algorithm for determining a user's proportions based on a bidimensional image of him.

### SUMMARY

An object of an embodiment of the present invention is to overcome all or part of the disadvantages of known automated motor vehicle seat configuration techniques.

Another object of an embodiment of the present invention is to provide a technique for acquiring morphologic data of the user.

Another object of an embodiment of the present invention is to avoid the storage of a photograph in the mass storage or non-volatile memory of a camera.

To achieve all or part of these and other objects, a system for adjusting a motor vehicle seat based on a user's measures is provided, wherein said measures are taken from a touchscreen of a device equipped with a camera, the length of the measure templates superimposed to an image of the user being adapted to correspond to the image.

According to an embodiment of the present invention, the adaptation of the template length is performed by the user by means of the touchscreen.

According to an embodiment of the present invention, the user's image is exclusively stored in a volatile memory of the device.

According to an embodiment of the present invention, the measures are stored in a non-volatile memory of the device.

According to an embodiment of the present invention, ratios between the measures are exploited to select a user model from a database and adapt the seat according to this model.

According to an embodiment of the present invention, the measures comprise the knee height, the thigh length, and the chest height.

A smartphone adapted to the system is also provided.

A motor vehicle seat adapted to the system is also provided.

### BRIEF DESCRIPTION OF THE DRAWINGS

The foregoing and other objects, features, and advantages of the present invention will be discussed in detail in the following non-limiting description of specific embodiments in connection with the accompanying drawings, among which:

FIG. 1 is a very simplified representation of an example of motor vehicle seat;

FIG. 2 illustrates, in the form of blocks, an embodiment of an automated motor vehicle seat configuration system;

FIG. 3 is a block diagram illustrating seat configuration steps;

FIGS. 4A and 4B are respective lateral and front views of a device for acquiring a user's measures;

FIGS. 5A and 5B illustrate an example of measures; and

FIG. 6 is a block diagram illustrating an example of use of the memories of the measurement device.

### DETAILED DESCRIPTION

The same elements have been designated with the same reference numerals in the different drawings. For clarity, only those steps and elements which are useful to the understanding of the described embodiments have been detailed. In particular, the actual seat adjustment mechanisms have not been detailed, the described embodiments being compatible with usual electrically adjustable seats. Further, the algorithms and models used to determine the respective positions of a user's joints based on his external measures have not been detailed either, the described embodiments being compatible with usual algorithms and models.

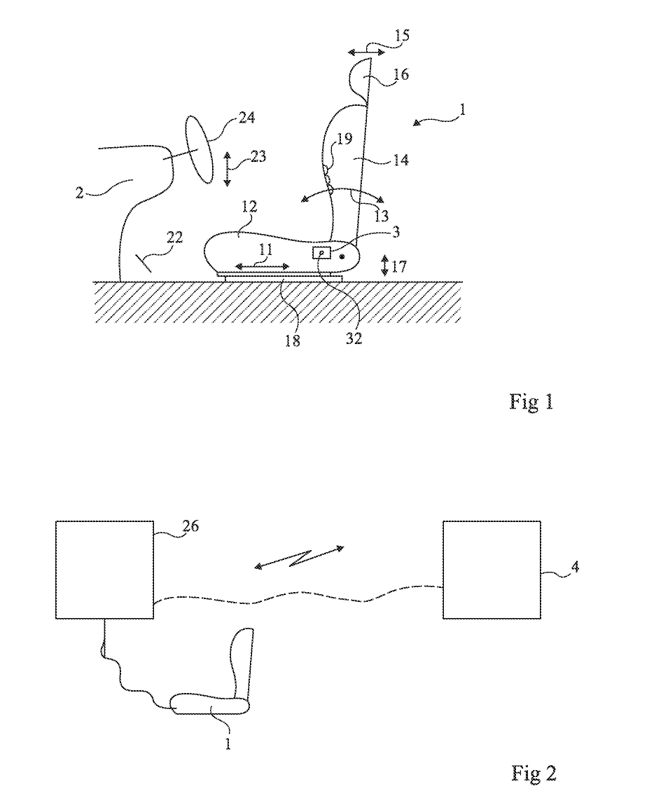

FIG. 1 is a simplified representation of a motor vehicle seat 1 of the type to which the embodiments which will be described apply.

Such a seat is generally formed of a seat bottom piece 12 to which is jointed a backrest 14, most often topped with a headrest 16. The seat is mounted on slide rails 18 enabling to adjust (arrow 11) the position of seat bottom piece 12 (in the shown example of a driver seat) with respect to pedal assembly 22 and to wheel 24 of vehicle 2. In the case of a passenger seat, this adjustment is performed with respect to the seat environment in the vehicle.

In the simplified example of FIG. 1, seat 1 is adjustable in terms of inclination (arrow 13) of its backrest 14 with respect to seat bottom piece 12, of longitudinal headrest position (arrow 15) as well as of height (arrow 17) of seat 1. Other adjustment points such as an adjustment of lumbar support cushions 19 or a height adjustment (arrow 23) of wheel 24 may also be provided.

The seat adjustments are accessible to the user generally via a control device 3 housed in a flange of seat bottom piece 12 or in the vehicle dashboard. Device 3 comprises several actuators, not shown, enabling to configure the seat. Among these actuators, a control member 32 is used to perform an automated seat adjustment or pre-adjustment according to the user's morphology. This adjustment is for example performed according to data stored in the on-board computer of the vehicle.

The user is for example identified by identification of the key that he uses, by means of an entry on the on-board computer, by means of a control button, by recognition by means of a camera contained in the passenger compartment of a vehicle, etc.

FIG. 2 illustrates, in the form of blocks, an embodiment of a system of automated adjustment of a motor vehicle seat 1.

This system uses on-board computer 26 of the vehicle to store the adjustment parameters associated with the user and, possibly, calculate these parameters from morphological data entered in on-board computer 26. The morphological data or adjustment parameters for example originate from a measure acquisition and processing device 4. As a specific embodiment, device 4 is a mobile telecommunication device of smartphone type.

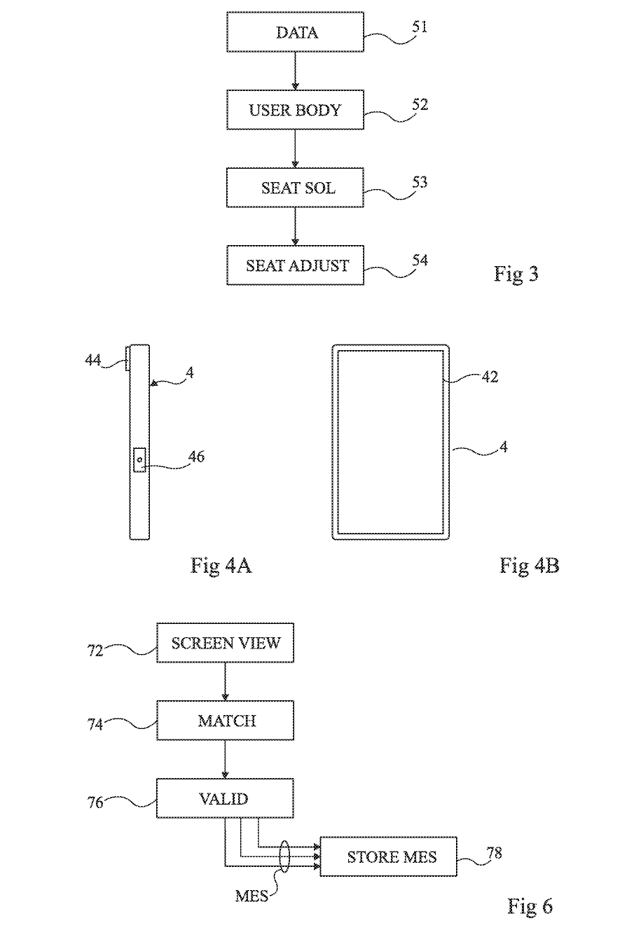

FIG. 3 schematically illustrates steps of a process for adjusting seat 1 of the motor vehicle.

A first step 51 (DATA) comprises acquiring data relative to the user, among which morphological data, and especially measures of limbs or of portions of the user's body. A second step 52 (USER BODY) comprises exploiting these morphological data to extract therefrom a model of the user's body and especially the respective positions of his limbs. A third step 53 (SEAT SOL) comprises using the estimate obtained at the previous step to determine the seat adjustments. Finally, a step 54 (SEAT ADJUST) comprises controlling the elements for electrically adjusting seat 1 according to the parameters determined at the previous step.

The seat adjustment or pre-adjustment may be performed as the user is installing himself in the vehicle or may be controlled by other environmental parameters such as, for example, the nature of the road where the vehicle is traveling (right-hand portion or curved portion of the road, roadway condition), the vehicle speed, the weather conditions, etc.

The described embodiments more specifically aim at the acquisition of the user's morphological data (step 51) and, among these, measures to deduce the adjustments to be made to the seat.

FIGS. 4A and 4B are respective simplified lateral and front views of a device 4 for acquiring measures to implement the seat adjustment such as described in relation with FIG. 3.

According to this embodiment, device 4 for example is a smartphone equipped, at its front surface, with a touchscreen 42 used as a user interface. The device is also equipped, for example, at its rear surface, with a digital camera 44.

Digital camera 44 is not used to take a picture of the user to be exploited in image processing to determine the user's external dimensions, but is used to display, in real time on touchscreen 42 of the telephone, the user's image so that said user gradually validates the measures.

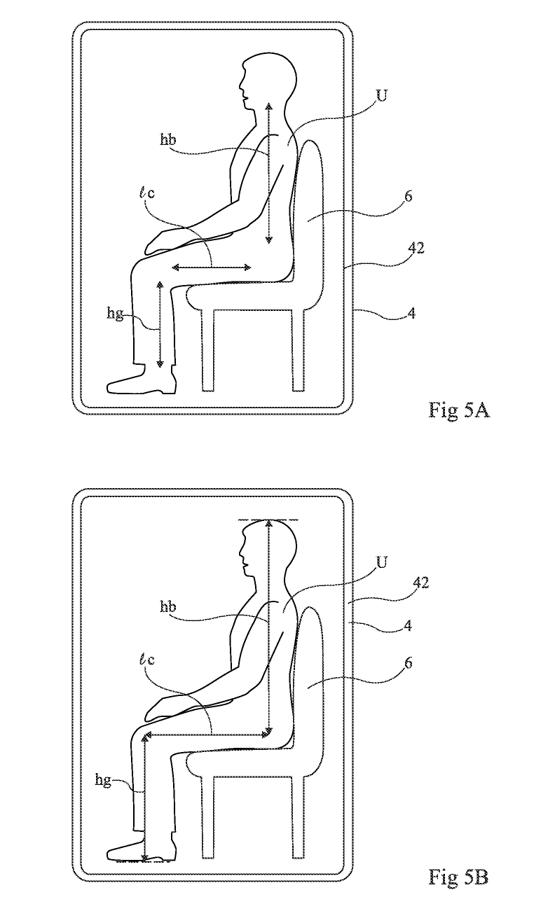

FIGS. 5A and 5B illustrate an embodiment according to this system.

Assume a user U seating on a seat 6. A third party or operator (not shown) holding device 4 and aiming at user U by means of camera 44, exploits the direct display on touchscreen 42 to determine the user's measures. For example, device 4 executes an application which previously places the desired dimension marks. To measure, for example, knee height hg, thigh length lc, and chest height hb, and knowing that the user will be seen seated, the system places in screen 42 three rectilinear stepped arrows hg, lc, hb symbolizing the user's position. The operator of device 4 then uses the touchscreen to have arrows hb, lc, and hg (FIG. 5B) correspond to the user's image that he sees (by enlarging, shortening, and adjusting the positions of the lines appearing on screen). Once all the arrows have been properly placed, the operator presses on a virtual or physical Enter key 46 (FIG. 4A) of the telephone. Once the measures have been validated, they are exploited by the system to determine, from the user models, the different parameters enabling to adjust the seat.

FIGS. 5A and 5B illustrate a simplified example and other measures may be taken to improve the adjustment accuracy. The nature and the number of measures depend on the nature of the seat adjustments and on the models and algorithms used for the determination of the adjustment parameters.

As a variation, rather than superimposing lines or arrows, the measure templates superimposed to the image may be images of slide calipers or of rulers.

According to another variation, the user is not in seated position, but takes another position (for example, standing or lying down). The operator takes the measures in the same way, adapting the lengths of the measure templates.

FIG. 6 illustrates the storage steps in the embodiment of FIGS. 5A and 5B. All the phases illustrated in FIGS. 5A and 5B are performed in a volatile memory or RAM. This means that the views digitally captured by camera 44 (block 72 SCREEN VIEW) are not stored in the non-volatile memory (NVM) or mass storage of the device but remain in its volatile memory (RAM). Similarly, the steps of adaptation of measures hb, lc, and hg (block 74, MATCH) are also performed by using the volatile memory. When the operator validates (block 76, VALID) the measures, all the obtained measures MES are transferred to the non-volatile memory (block 78, STORE MES). The measures contained in the non-volatile memory are then used by the different algorithms to determine the seat adjustment parameters.

By avoiding an image capture and storage for a subsequent image processing to determine the user's measures, it is avoided to use the mass or non-volatile memory of the device. Further, RAM accesses are generally faster and the process is thus accelerated. Further, by only storing the values of measures MES, the space taken up by the data necessary to implement the method in this non-volatile memory is durably limited, such measures taking up less space than an image.

Different data processing processes may be implemented.

For example, the method described in international application PCT-US-20110545084 of the applicant may be used for inspiration, or other known processings may be applied.

According to another preferred embodiment, the three measures hg, lc, and hb are exploited as follows.

The measures are obtained in number of pixels. To avoid having to convert these measures to the metric system, ratios between measures are exploited. For example, the following three ratios and sum are calculated:

R1=lc/hb;

R2=hg/hb;

R3=lc/hg; and

S=1+R1+R2.

The user's weight and size (data entered by the user or extracted from a memory of the smartphone or of the processing computer) are also taken into account.

Based on these data, the system determines the user's corpulence model from among a set of recorded models. This determination comprises determining the model to which the user is closest. Once this model has been determined, the pre-adjustment is performed based on the seat adjustments associated with this model.

Various embodiments have been described, various alterations and modifications will occur to those skilled in the art. In particular, the selection of the user's measures to be taken into account depends on the adjustment algorithm used. Further, the practical implementation of the described embodiments is within the abilities of those skilled in the art based on the functional indications given hereabove by using programming and modeling tools usual per se.

1. A method for adjusting a motor vehicle seat based on a user's measures, wherein said measures are taken from a touchscreen of a device equipped with a camera, the length of the measure templates superimposed to an image of the user being adapted to correspond to the image.

2. The method of claim 1, wherein the adaptation of the template length is performed by the user by means of the touchscreen.

3. The method of claim 1, wherein the user's image is exclusively stored in a volatile memory of the device.

4. The method of claim 1, wherein the measures are stored in a non-volatile memory of the device.

5. The method of claim 1, wherein ratios between the measures are exploited to select a user model from a data base and adapt the seat according to this model.

6. The method of claim 1, wherein the measures comprise the knee height, the thigh length, and the chest height.

7-9. (canceled)

10. The method of claim 5, wherein user entered data in addition to ratios of the measures are used to determine the user model.

11. A system for adjusting motor vehicle seats based on a user's measures, said system comprising:
a device having a touchscreen equipped with a camera; and
means for taking the user's measures from the touchscreen of the device equipped with the camera, the length of the measure templates superimposed to an image of the user being adapted to correspond to the image.

12. The system of claim 11, wherein the adaptation of the template length is performed by the user by means of the touchscreen.

13. The system of claim 11, wherein the device comprises volatile memory, and the user's image is exclusively stored in the volatile memory of the device.

14. The system of claim 11, wherein the device comprises non-volatile memory, and the measures are stored in the non-volatile memory of the device.

15. The system of claim 11, wherein the means uses ratios between the measures to select a user model from a data base and adapt the seat according to this model.

16. The system of claim 15, wherein the means uses user entered data in addition to ratios between the measures to select the user model.

17. The system of claim 11, wherein the measures comprise the knee height, the thigh length, and the chest height.

18. The system of claim 11 wherein the system further comprises a smartphone.

19. The system of claim 11 wherein the system further comprises a motor vehicle.

20. A smartphone adapted to communicate with a motor vehicle in order to adjust motor vehicle seats based on a motor vehicle occupant's measures, said smartphone comprising:
a touchscreen;
a camera;
means for taking the user's measures from the touchscreen, the length of the measure templates superimposed to an image of the motor vehicle occupant being adapted to correspond to the image; and
a communication device adapted to send morphological data relating to the motor vehicle seat occupant to the motor vehicle.

21. The smartphone of claim 20, further comprising volatile memory, and the user's image is exclusively stored in the volatile memory.

22. The smartphone of claim 20, further comprising non-volatile memory, and the measures are stored in the non-volatile memory of the device.

23. The smartphone of claim 20, wherein the means uses ratios between the measures to select a model of the vehicle occupant from a data base and adapt the seat according to this model.
